(19) United States
(12) Patent Application Publication
(10) Pub. No.: US 2025/0317520 A1
(43) Pub. Date: Oct. 9, 2025

(54) INFORMATION PROCESSING APPARATUS AND METHOD FOR INFORMATION PROCESSING APPARATUS

(71) Applicant: CANON KABUSHIKI KAISHA, Tokyo (JP)

(72) Inventor: JUNICHI SUWA, Chiba (JP)

(21) Appl. No.: 19/097,232

(22) Filed: Apr. 1, 2025

(30) Foreign Application Priority Data
Apr. 4, 2024 (JP) 2024-060664

(51) Int. Cl. H04N 1/00

(52) U.S. Cl. CPC H04N 1/00029; H04N 1/00082; H04N 1/0009; H04N 1/00413; H04N 2201/0094

(57) ABSTRACT

An information processing apparatus includes a display, at least one processor, and at least one memory that is in communication with the at least one processor. The at least one memory stores instructions for causing the at least one processor and the at least one memory to control the display to display a plurality of items corresponding to a plurality of executed jobs, accept a selection of an item from the plurality of items, perform a diagnosis of the information processing apparatus based on acceptance of the selection of the item, and, in a case where the plurality of items is displayed, perform a diagnosis without the selection of the item.

### BACKGROUND

### Field of the Disclosure

The present disclosure relates to a technique of diagnosing an apparatus.

### Description of the Related Art

There are a wide variety of and a number of information processing apparatuses that process information such as image data. A failure is inevitable in such an information processing apparatus. When a failure occurs, it is necessary to fix the failure. However, if a user does not know the cause of the failure, he or she would be at a loss. To solve such difficulties, an apparatus including a diagnosis unit is proposed to allow the apparatus to determine the cause of the failure and provide the cause of the failure to the user. The following description is given taking a multi-function peripheral as an example of the information processing apparatus.

There is a case where error termination occurs at the time of printing using the multi-function peripheral, and there is a case where an output product is not as expected even at the time of normal termination. When such a failure occurs, the user solves a problem by making an inquiry to a call center or asking for a service engineer to be dispatched to the user.

When an inquiry is made to a call center or a service engineer is dispatched as described above, it takes time until the failure of the multi-function peripheral is solved in many cases. There is also a case where the user cannot operate the multi-function peripheral until the failure is solved, which is inconvenient for the user.

To reduce such cases of making inquiries to call centers and asking for service engineers to be dispatched, for example, there is a need for provision of a diagnosis function that allows the user to solve a failure by himself or herself, as discussed in Japanese Patent Application Laid-Open No. 2012-163805.

A scene where the user recognizes a failure of an apparatus is often caused by a job executed by the apparatus. Thus, a diagnosis is desirably performed with use of information regarding a job. In this regard, in an apparatus that performs a diagnosis, a configuration is proposed where a list of jobs executed by the apparatus is displayed and the user selects a job displayed on the list. The apparatus performs a diagnosis using information regarding the selected job.

However, it is conceivable that the user forgets what kind of failure has occurred in what kind of job in the above-mentioned configuration. Further, it is also conceivable that a job history is periodically deleted from a viewpoint of information security. As a result, when a diagnosis is performed, it is impossible to select a job to be used for the diagnosis. When it is impossible to select a job, it is impossible to perform such a diagnosis.

### SUMMARY

According to an aspect of the present disclosure, an information processing apparatus having a function of executing a job includes a display, at least one processor; and at least one memory that is in communication with the at least one processor. The at least one memory stores instructions for causing the at least one processor and the at least one memory to control the display to display a plurality of items respectively corresponding to a plurality of jobs executed by the information processing apparatus, accept a selection of an item from the plurality of items, perform a diagnosis of the information processing apparatus regarding the item based on acceptance of the selection of the item, and, in a case where the plurality of items is displayed, perform a diagnosis of the information processing apparatus without the selection of the item from the plurality of items.

Further features of various embodiments will become apparent from the following description of exemplary embodiments with reference to the attached drawings.

### BRIEF DESCRIPTION OF THE DRAWINGS

FIG. 1 is a block diagram illustrating a hardware configuration of an image forming apparatus according to a first exemplary embodiment.

FIG. 2 is a diagram illustrating a software configuration of the image forming apparatus according to the present exemplary embodiment.

FIG. 3 is a flowchart of processing of storing job information as a job log.

FIG. 4 is a diagram illustrating the job log.

FIG. 5 is a flowchart of diagnosis processing.

FIG. 6 is a view illustrating a screen displayed when a diagnosis content is selected.

FIG. 7 is a view illustrating screen display of a job list.

FIG. 8 is a flowchart executed when items to be displayed on the job list are extracted.

FIG. 9 illustrates an extraction table to be used for extracting the items displayed on the job list.

FIG. 10 is a flowchart executed by a diagnosis unit 203.

FIG. 11 illustrates a countermeasure list that is displayed as a diagnosis result.

FIG. 12 is a view illustrating display of a result of a diagnosis.

FIG. 13 is a flowchart executed by the diagnosis unit 203.

FIG. 14 is a view illustrating display of a result of a diagnosis.

FIG. 15 is a flowchart executed by the diagnosis unit 203 according to a second exemplary embodiment.

FIG. 16 illustrates an example of a screen displayed when a diagnosis according to the second exemplary embodiment is performed.

### DESCRIPTION OF THE EMBODIMENTS

In a first exemplary embodiment, a description will be given of, as an example, an image forming apparatus that executes a diagnosis even in a case where there is no job to be selected by a user on a job list corresponding to a diagnosis content and that enables browsing of countermeasures.

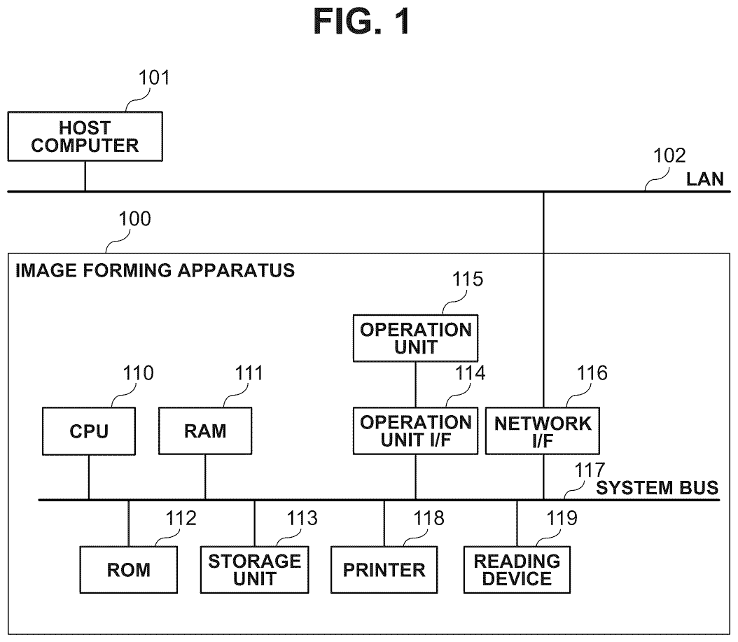

FIG. 1 is a diagram illustrating a system to be applied to the present exemplary embodiment. In the system, a host computer 101 and an image forming apparatus 100 are connected to each other via a local area network (LAN) 102. The user causes the host computer 101 to generate print data and causes the host computer 101 to transmit the print data to the image forming apparatus 100 via the LAN 102. The image forming apparatus 100 in the present exemplary embodiment includes a print unit that performs printing. The image forming apparatus 100 may be either a multi-function printer (MFP) or a single function printer (SFP). A printer having a plurality of functions such as a facsimile (FAX) function, a copy function, a print function, and a scan function is called the MFP, and a printer having only the print function (print unit) is called the SFP.

### Hardware Configuration of Image Forming Apparatus

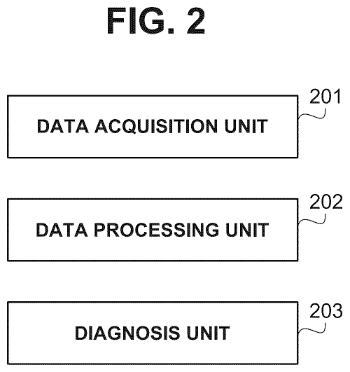

A hardware configuration example of the image forming apparatus 100 according to the first exemplary embodiment is described with reference to FIG. 1. A central processing unit (CPU) 110 is a central control unit of the image forming apparatus 100 and centrally controls each device connected to a system bus 117. A random-access memory (RAM) 111 is a storage device that can be accessed by the CPU 110 and is used as a work memory for the CPU 110 to operate. A program is stored in a read-only memory (ROM) 112. The CPU 110 loads the program into the RAM 111 and executes the program, whereby each software module illustrated in FIG. 2, which is to be described below, operates. A storage unit 113 is, for example, a hard disk drive, and stores system software for various kinds of processing, acquired print data, and the like. An operation unit interface (I/F) 114 is an interface unit for an operation unit 115, and outputs operation screen data to the operation unit 115. The operation unit 115 includes a display unit for displaying various kinds of menus, information regarding print data for which a print instruction has been issued, and the like. Additionally, the operation unit I/F 114 transmits information input by a user via the operation unit 115 to the CPU 110. A network I/F 116 is an interface for exchanging information with an external apparatus (for example, the host computer 101) via the LAN 102. In the present exemplary embodiment, assume that page description language (PDL) data is received as print data from the external apparatus.

A printer 118 is a print engine that performs printing on a recording medium (such as paper) according to PDL data interpreted by the CPU 110.

A reading device 119 is a device including a reading unit (e.g., scanner) that reads a document. The reading device 119 can convert the document read by the reading unit into data. The image that has been converted into data can be transmitted to the external apparatus through network communication performed by the image forming apparatus 100. It is also possible for the CPU 110 to cause the storage unit 113 to store data read by the reading device 119. A job transmitted by the transmission unit is referred to as a SEND job.

FIG. 2 is a diagram illustrating an example of a software configuration of the image forming apparatus 100. The image forming apparatus 100 includes software modules illustrated in FIG. 2. As described above, the CPU 110 executes the program loaded from the ROM 112 into the RAM 111 to cause these software modules to operate. Here, the software modules included in the image forming apparatus 100 will be illustrated and explained using three module units: a data acquisition unit 201, a data processing unit 202, and a diagnosis unit 203.

The data acquisition unit 201 receives PDL data. The data processing unit 202 interprets the received PDL data and executes print processing. Further, the data processing unit 202 leaves information regarding the PDL data and information regarding a print result as a job log, which is a record of the job. The diagnosis unit 203 executes diagnosis processing and displays a diagnosis result on the operation unit 115 based on a diagnosis content and a selected job (item). The user selects one of countermeasures included in the diagnosis result.

Details of the selected countermeasure are displayed on the operation unit 115.

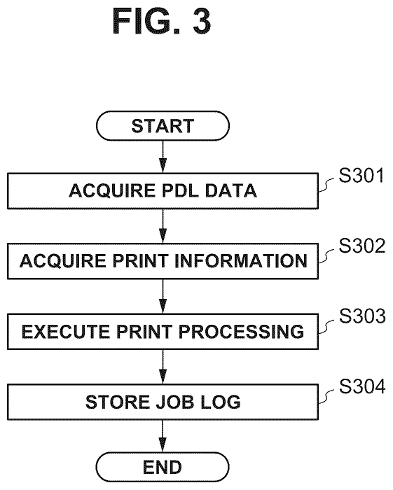

FIG. 3 is a flowchart illustrating a flow of processing executed by the CPU 110 from acquisition of PDL data and execution of print processing to storage of data as a job log. In step S301, the CPU 110 causes the data acquisition unit 201 to receive PDL data via the network I/F 116. Also, regarding the acquisition of PDL data, a configuration of acquiring PDL data retained in the storage unit 113 in the image forming apparatus 100 may be used.

In step S302, the data acquisition unit 201 acquires print information. The print information mentioned herein is information regarding the acquired PDL data, information that is required in processing of printing the PDL data, or information to be left as the job log. Examples of the print information include information regarding an operating system (OS), a driver, and an application that are used for creating the PDL data and include information regarding driver settings, such as a paper size, a paper type, and a page layout. Other examples of the print information include main body setting information that is stored in the storage unit 113 of the image forming apparatus 100, such as halftone and thickness adjustment. When acquiring the print information, the data acquisition unit 201 analyzes the PDL data and acquires print settings added to the PDL data. Also, the data acquisition unit 201 acquires print settings stored in the storage unit 113 of the image forming apparatus 100. Examples of a method of acquiring the information regarding the OS and the application that are used for creating the PDL data include a method of adding the information to the PDL data and acquiring the information from the PDL data and include a method of acquiring the information separately from the PDL data via the network I/F 104.

In step S303, the CPU 110 causes the data processing unit 202 to execute print processing. In the print processing, the data processing unit 202 analyzes the acquired PDL data and generates intermediate data corresponding to the number of pages. Subsequently, the data processing unit 202 executes raster image processor (RIP) processing based on the generated intermediate data and performs image forming processing to convert the data into an image in a raster format. Thereafter, the CPU 110 performs image processing on the image in the raster format, and the printer 118 prints the rasterized image that has undergone the image processing on a recording medium.

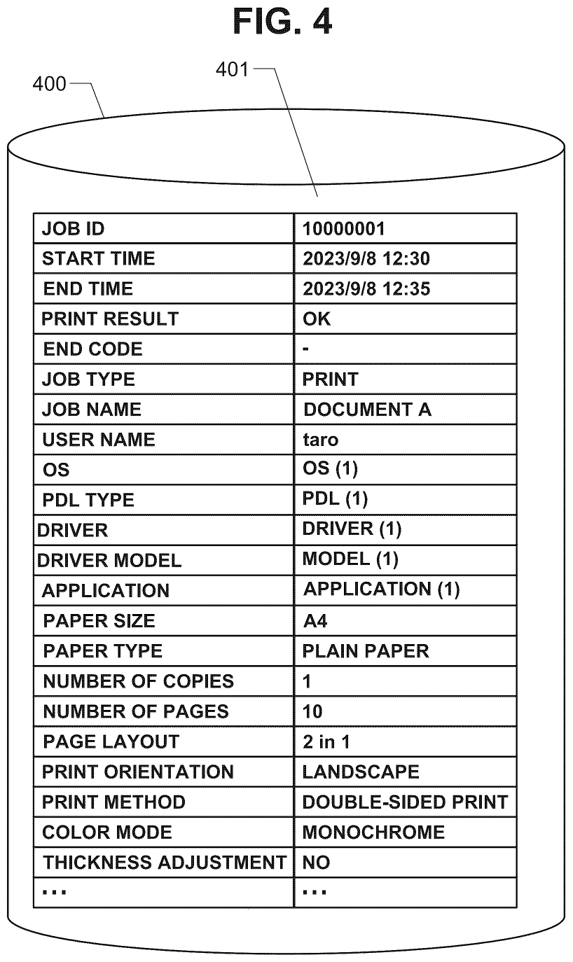

In step S304, the CPU 110 causes the data processing unit 202 to execute processing of storing the job log. In the processing of storing the job log, the data processing unit 202 leaves information regarding the PDL data that has undergone the print processing in the storage unit 113 as the job log. The data processing unit 202 constructs a job log database (DB) in the storage unit 113, and the data processing unit 202 stores the created job log together with previous job logs in the job log DB. An example of the job log DB and an example of the job log are illustrated in FIG. 4. FIG. 4 illustrates a job log DB 400 and illustrates a job log 401 as an example of the job log. Information acquired before a start of the print processing, a print result, and the like are stored in the job log. Specific items of the job log 401 are described below.

“Job ID” is a unique value that identifies a job.

“Start time” is the time at which the print processing is started.

“End time” is the time at which the print processing is ended.

“Print result” is a value indicating a result of the print processing. At the time of normal termination, the value is “OK”. At the time of abnormal termination, the value is “error”.

“End code” is an identification number for identifying an error message in a case where the print result is “error”. In a case where the print result is “OK”, the end code is “-”.

“Job type” represents a type of job, such as FAX, copy, print, and scan.

“Job name” represents the name of a printed file.

“User name” represents the name of a user who has executed printing.

“OS” represents an operating system (OS) of a terminal of the user who has executed printing.

“PDL type” represents a type of PDL data.

“Driver” represents the name of a driver used in printing. In a case where a driver is not used in direct printing, “-” is indicated.

“Driver model” represents the model of the driver used in printing.

“Application” represents the name of an application that executes printing.

“Paper size” represents a paper size, such as A4, B4, and postcard.

“Paper type” represents a paper type, such as plain paper, thick paper, and envelope.

“Number of copies” represents the number of print products to be printed with the same content.

“Number of pages” represents the number of pages of the PDL data.

“Page layout” represents a setting such as N-in-one print.

“Print orientation” represents a setting such as a portrait and a landscape.

“Print method” represents a setting such as one-sided printing and double-sided printing.

“Color mode” represents a color setting, such as color, monochrome, and auto.

“Thickness adjustment” represents a setting of thickening a text, a line, graphics, and the like.

The items that have been introduced above and that are to be left on the job log are merely examples and are not limited thereto. In the job log DB 400, respective job logs of jobs are accumulated. The job log DB 400 is used for display of a job history, a diagnosis, and the like.

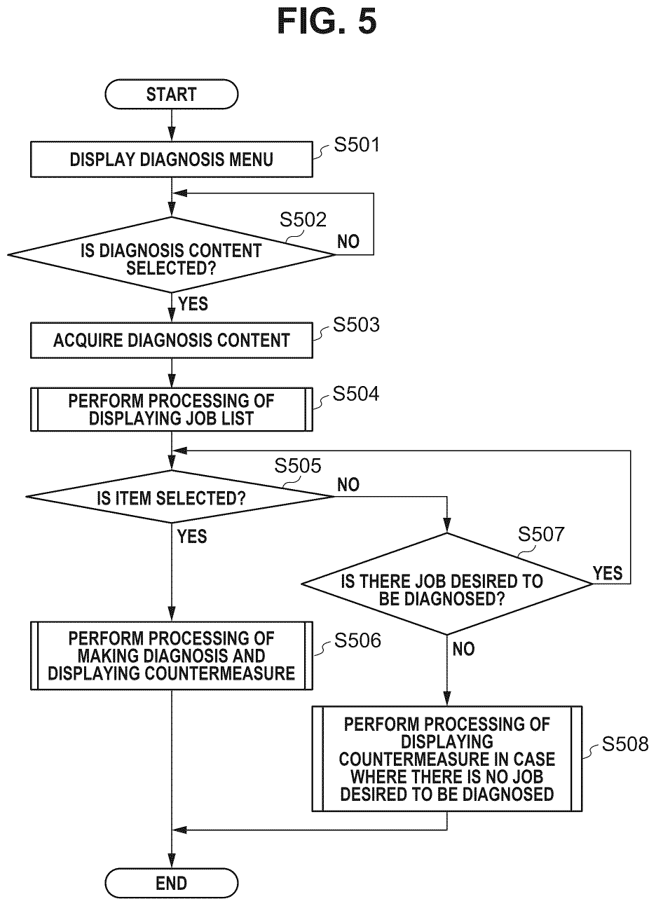

FIG. 5 is a flowchart of diagnosis processing. In the present exemplary embodiment, a description is given taking the image forming apparatus 100 as an example. The image forming apparatus 100 includes the diagnosis unit 203 for diagnosing a failure of the image forming apparatus 100. This configuration allows the image forming apparatus 100 to provide a cause of the failure of the image forming apparatus 100 to the user to eliminate the failure without asking for a service engineer to be dispatched. The image forming apparatus 100 according to the present exemplary embodiment accepts a diagnosis content and a job to be used for a diagnosis from the user when the diagnosis unit 203 performs a diagnosis. This is because the user recognizes a failure of the image forming apparatus 100 based on a job in many cases. Thus, the image forming apparatus 100 accepts the job as a material to be used for a diagnosis from the user, and the image forming apparatus 100 is thereby capable of providing an appropriate countermeasure for the failure assumed by the user.

Details of diagnosis processing performed by the diagnosis unit 203 are described below.

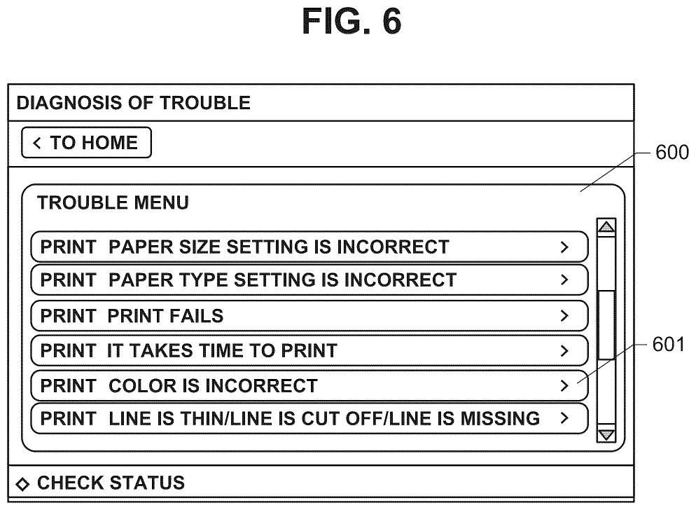

The description starts with step S501. First, the CPU 110 displays a diagnosis menu 600 on the operation unit 115. The diagnosis menu 600 is a list of diagnosis contents. FIG. 6 is a view illustrating a display screen of the operation unit 115. The diagnosis menu 600, which is the list of diagnosis contents, is displayed on the display screen. Each diagnosis content 601 is displayed in the diagnosis menu 600.

In step S502, the diagnosis unit 203 performs processing of determining which diagnosis content 601 is selected from the diagnosis menu 600 illustrated in FIG. 6. The diagnosis unit 203, which accepts selection of a diagnosis content 601, accepts the selection of the diagnosis content 601. Specifically, the operation unit 115 detects that the diagnosis content 601 is pressed by the user, and the diagnosis content 601 is accepted.

In a case where the selection of the diagnosis content 601 is accepted by the diagnosis unit 203 (YES in step S502), the processing proceeds to step S503. In a case where the selection of the diagnosis content 601 is not accepted (NO in step S502), the diagnosis unit 203 is on standby until it accepts the selection of the diagnosis content 601.

In step S503, the diagnosis unit 203 acquires the selected diagnosis content 601.

Subsequently, in step S504, a job list is generated based on the diagnosis content 601, and the job list is displayed on the display screen of the operation unit 115 (a display unit).

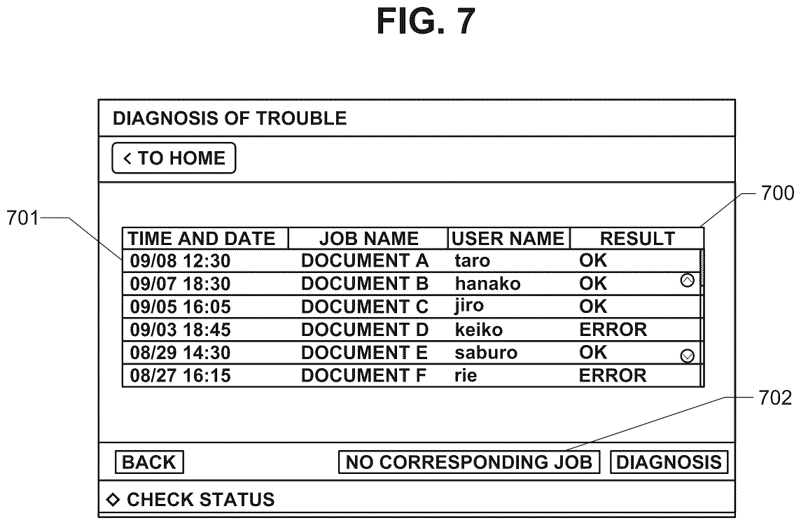

FIG. 7 illustrates an example of a screen on which the job list of jobs to be used for a diagnosis is displayed. Details of processing will be described below with reference to FIGS. 7 to 9.

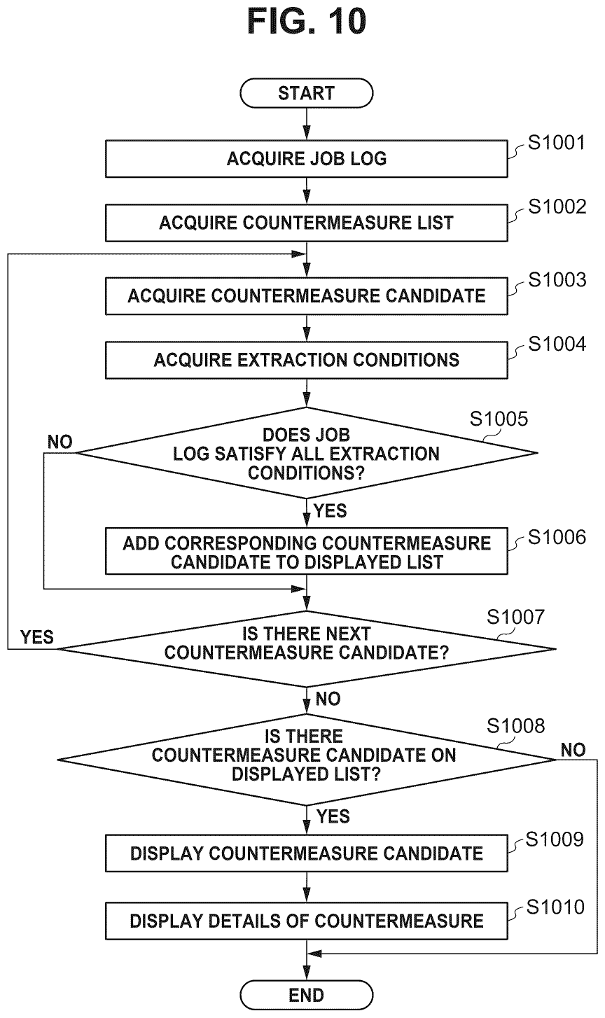

Subsequently, in step S505, the diagnosis unit 203 determines whether selection of an item 701 corresponding to the job to be diagnosed from the job list has been accepted. In a case where the selection of the item 701 (YES in step S505) has been accepted, the processing proceeds to step S506. In step S506, the diagnosis unit 203 performs first diagnosis processing of diagnosing a content of the job regarding the selected item 701 and displaying an appropriate countermeasure. Details will be described below with reference to FIGS. 10 to 12.

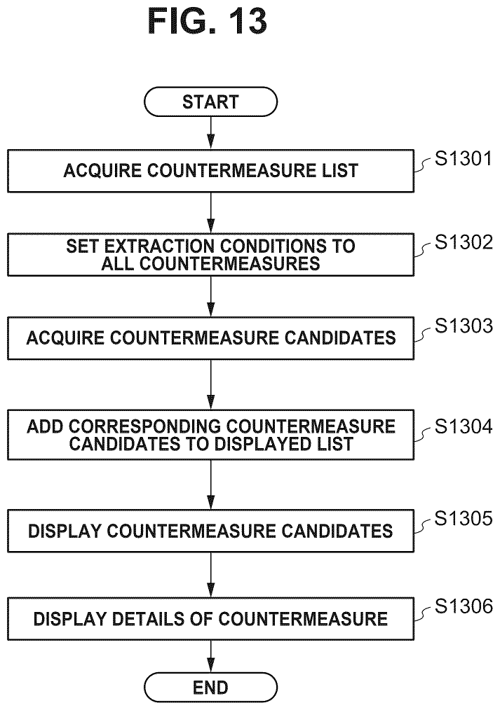

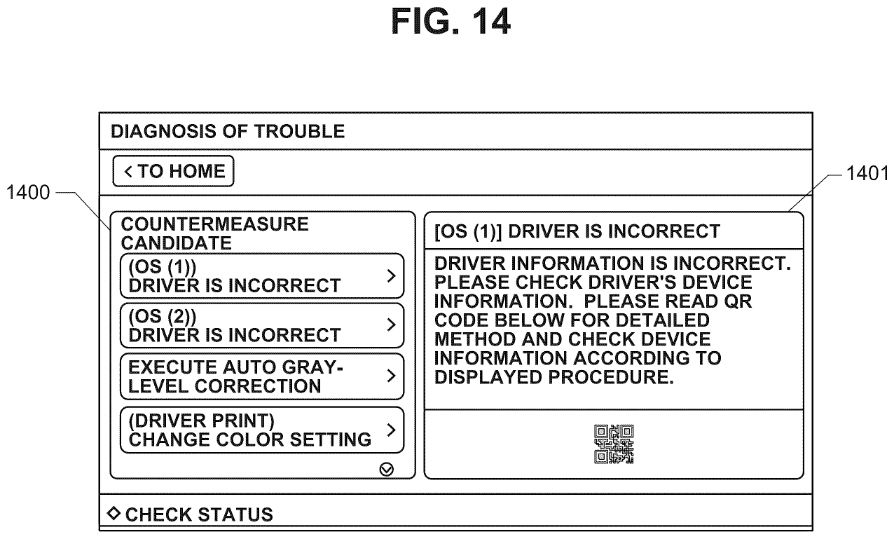

In a case where the item 701 corresponding to the job is not selected (NO in step S505), the processing proceeds to step S507. In step S507, the diagnosis unit 203 determines whether there is a job desired to be diagnosed. In a case where there is no job desired to be diagnosed (NO in step S507), the processing proceeds to step S508. In step S508, the diagnosis unit 203 performs second diagnosis processing of displaying a countermeasure in a case where there is no job desired to be diagnosed. Details will be described below with reference to FIGS. 13 and 14.

In a case where there is a job desired to be diagnosed (YES in step S507), the processing returns to the determination processing in step S505.

FIG. 7 is a view illustrating an example of a screen on which the job list to be used for a diagnosis is displayed. After a diagnosis content is selected from a diagnosis top menu illustrated in FIG. 6, the diagnosis unit 203 displays an item 701 corresponding to a job that is relevant to the diagnosis content on a display section 700 in the operation unit 115.

Respective items 701 corresponding to jobs in the job list are displayed on the display section 700.

Further, details of a job are displayed on an item-by-item basis. It is possible for the user to select an item 701 and press a diagnosis button displayed at the lower right after selection of the item 701, whereby a diagnosis is started. Pressing of the diagnosis button is an example of an instruction for execution of a diagnosis.

Examples of details of a content to be displayed on the item-by-item basis include a “time and date”, “job name”, “user name”, and “result”. In the present exemplary embodiment, a “no corresponding job” selection button 702 is provided as a selection button to be pressed in a case where no item regarding the job desired to be diagnosed is displayed on the job list.

In a case where a predetermined diagnosis content is selected, the selection button 702, which is pressed in a case where there is no job, may not be displayed. For example, in a case where the above-mentioned SEND job is selected, the selection button 702 is not displayed.

Displaying of the job list in step S504 in FIG. 5 is now described in detail. As an example, displaying of the job list in a case where a menu button regarding the diagnosis content 601 of “color is incorrect” of the “print” function is pressed will be described with reference to FIGS. 7 to 9.

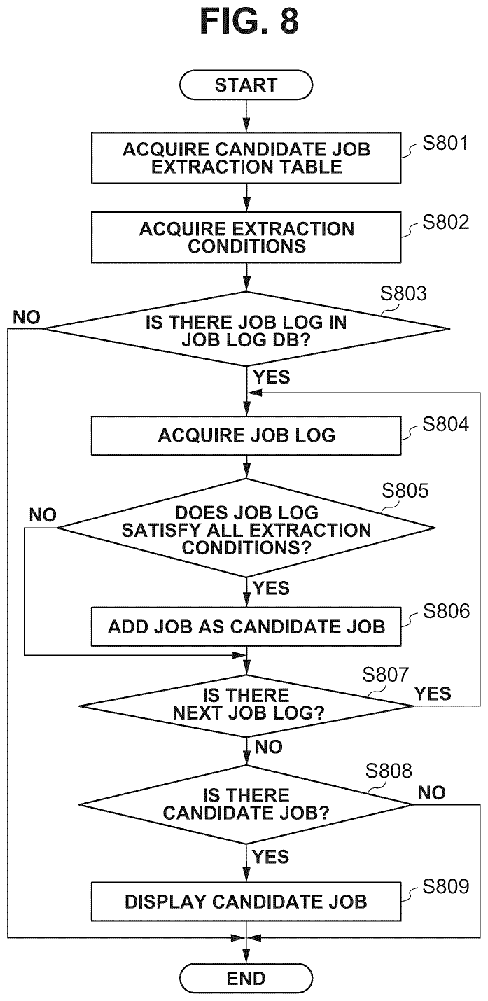

FIG. 8 is a flowchart illustrating a flow of job list display processing executed by the CPU 110.

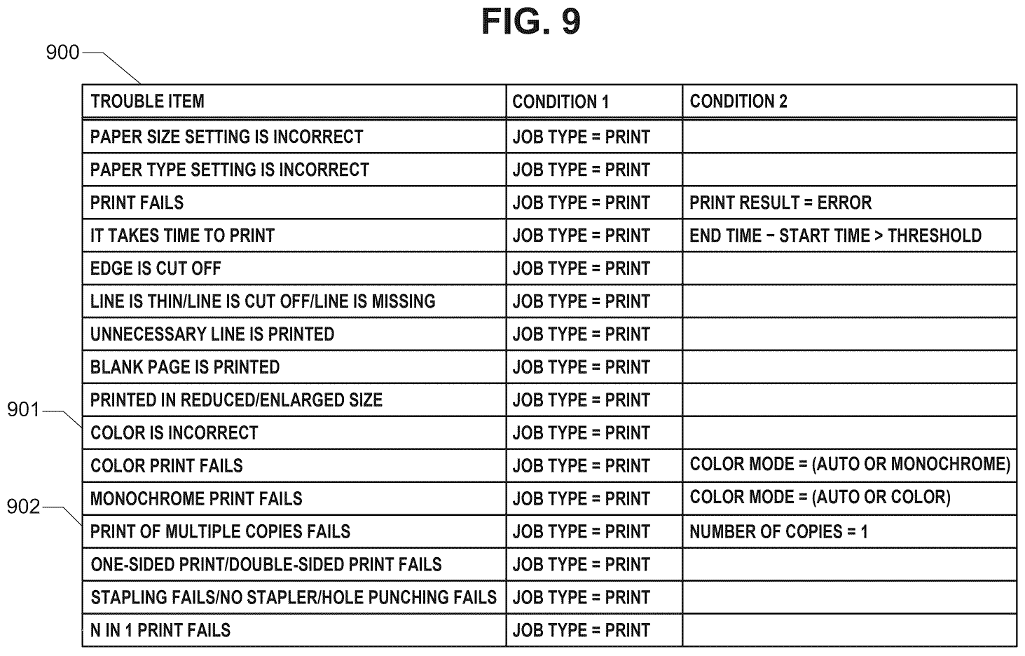

In step S801, the CPU 110 causes the diagnosis unit 203 to acquire a candidate job extraction table 900 illustrated in FIG. 9. In step S802, when pressing of the menu button regarding the diagnosis content 601 of “color is incorrect” is accepted, the diagnosis unit 203 acquires a candidate job extraction condition of an item 901 of “color is incorrect” from the candidate job extraction table 900. The candidate job extraction condition of the item 901 of “color is incorrect” is that a job has a value of the job type matching “print”. In step S803, the diagnosis unit 203 checks whether there is a job log in the job log DB. In a case where there are one or more job logs (YES in step S803), the processing proceeds to step S804. In a case where there is no job log (NO in step S803), there is no candidate job to be displayed, and thus the processing ends. In step S804, the diagnosis unit 203 acquires one job log from the job log DB 400. In step S805, the diagnosis unit 203 checks whether the acquired job log satisfies all extraction conditions. In a case where the acquired job log satisfies all the extraction conditions (YES in step S805), the processing proceeds to step S806. In a case where the acquired job log does not satisfy all the extraction conditions (NO in step S805), the processing proceeds to step S807. In step S806, in the case where the acquired job log satisfies all the extraction conditions, the diagnosis unit 203 adds a corresponding job as a candidate job. For example, because an extraction condition of a candidate job for an item 901 of “edge is cut” is that a job has a value of the job type matching “print”, and the job log 401 satisfies the condition, the corresponding job is extracted as the candidate job. In step S807, the diagnosis unit 203 checks whether there is a job log that has not been compared with the extraction condition in the job log DB. In a case where there is a job log that has not been compared with the extraction condition (YES in step S807), the processing returns to step S804. In step S804, the diagnosis unit 203 acquires a new job log, and repeats the processing in steps S805 and S806. In a case where there is no job log that has not been compared with the extraction condition (NO in step S807), the processing proceeds to step S808. In step S808, the diagnosis unit 203 checks whether there is a candidate job that satisfies a condition. In a case where there is the candidate job (YES in step S808), the processing proceeds to step S809. In step S809, the diagnosis unit 203 displays the candidate job as an item so as to be selectable by the user on the operation unit 115. In a case where there is no candidate job (NO in step S808), there is no candidate job to be displayed, and thus the diagnosis unit 203 ends the processing without performing display.

While the description has been given taking the extraction of the candidate job for the diagnosis content corresponding to the item 901 of “color is incorrect” as an example, the extraction method is similar in a case where another diagnosis content is selected. For example, in a case where a diagnosis content corresponding to an item 902 of “print of multiple copies fails” is selected, the diagnosis unit 203 extracts a candidate job according to a condition of the item 902 of “print of multiple copies fails”. The diagnosis unit 203 acquires all jobs each having a value of the job type matching “print” and a value of the number of copies matching “1” from the job log DB 400.

In this manner, the diagnosis unit 203 extracts a candidate job according to a condition on the candidate job extraction table 900 in FIG. 9. While the description has been given of the extraction method using a condition associated with a diagnosis content, the diagnosis unit 203 may extract a candidate job in combination with a condition not associated with the diagnosis content (for example, extract 50 most recent jobs, extract a candidate job from jobs of a log-in user). Moreover, the condition associated with the diagnosis content is not limited to the above-mentioned condition.

Subsequently, regarding the display of the countermeasure in step S506 described with reference to FIG. 5, a description will be given of a case where the diagnosis content 601 of “color is incorrect” and the item 701 are selected as an example with reference to FIGS. 10 to 12.

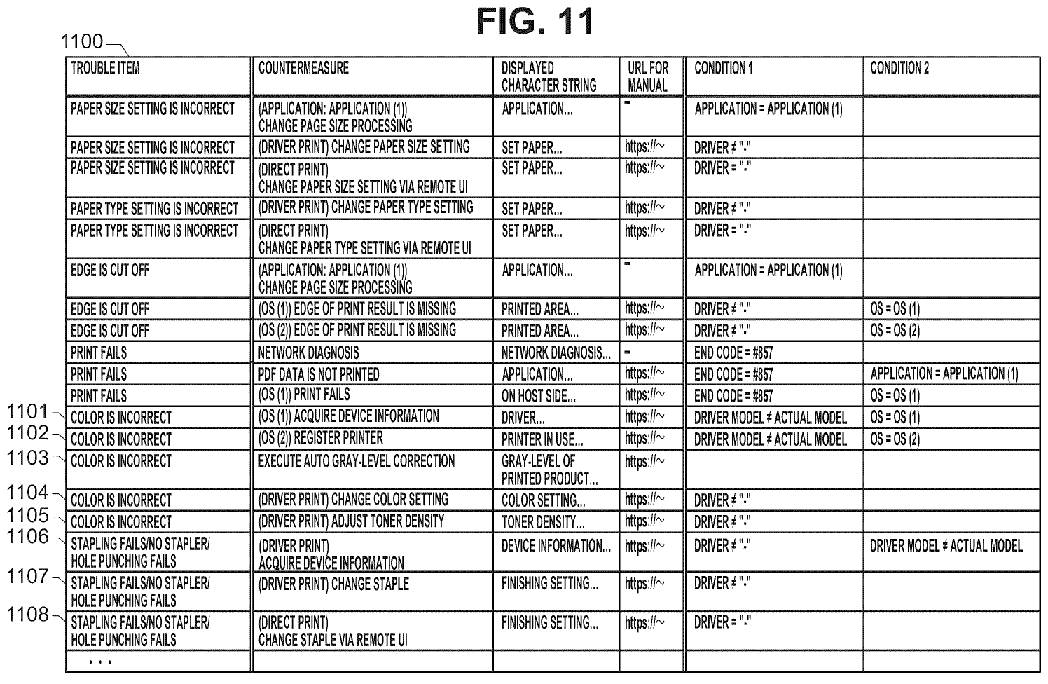

FIG. 10 is a flowchart related to the first diagnosis processing executed by the diagnosis unit 203. The flowchart illustrates a flow in which the CPU 110 causes the diagnosis unit 203 to narrow down countermeasure candidates for the diagnosis content based on the selected diagnosis content and item. After the diagnosis content 601 of “color is incorrect” and the item 701 are selected, the CPU 110 causes the diagnosis unit 203 to detect pressing of the diagnosis button. Then, in step S1001, the diagnosis unit 203 acquires a job log corresponding to the selected item. In this step, the diagnosis unit 203 acquires the job log 401 corresponding to the item 701. Subsequently, in step S1002, the diagnosis unit 203 acquires a countermeasure list 1100 in FIG. 11. In step S1003, the diagnosis unit 203 acquires one countermeasure candidate from the countermeasure list 1100. In step S1004, the diagnosis unit 203 acquires extraction conditions for determining whether the countermeasure candidate is to be extracted as the countermeasure candidate. In step S1005, the diagnosis unit 203 checks whether the acquired job log 401 satisfies all the extraction conditions. In a case where the acquired job log 401 satisfies all the extraction conditions (YES in step S1005), the processing proceeds to step S1006. In step S1006, the diagnosis unit 203 adds the corresponding countermeasure candidate to the displayed list. Then, the processing proceeds to step S1007. In a case where there is a condition that is not satisfied (NO in step S1005), the processing proceeds to step S1007. In step S1007, the diagnosis unit 203 checks whether there is any other countermeasure candidate that has not been compared with the extraction conditions. In a case where there is a countermeasure candidate that has not been compared with the extraction conditions (YES in step S1007), the processing returns to step S1003. In step S1003, the diagnosis unit 203 acquires a new countermeasure candidate, and repeats the processing from step S1004 to step S1006. In a case where there is no countermeasure candidate that has not been compared with the extraction conditions (NO in step S1007), the processing proceeds to step S1008.

For example, in a case where the diagnosis content 601 of “color is incorrect” is selected, items 1101 to 1105 on the countermeasure list 1100 are countermeasure candidates. The job log 401 is compared with respective extraction conditions of the items 1101 to 1105. Extraction conditions of a countermeasure of “(OS (1)) acquire device information” for the item 1101 are “driver model≠actual model” as a condition 1 and “OS=OS (1)” as a condition 2. The job log 401 indicates that “driver model=model (1)”, which satisfies the condition 1, and the diagnosis unit 203 compares the driver model with device information (own model information) and confirms that the driver model does not match the device information. Furthermore, since the job log 401 indicates that “OS=OS (1)”, which satisfies the condition 2, the diagnosis unit 203 adds the countermeasure candidate to the displayed list.

Extraction conditions of a countermeasure of “(OS (2)) register printer” for the item 1102 are “driver model≠actual model” as the condition 1 and “OS=OS (2)” as the condition 2. The job log 401 indicates that “driver model=model (1)”, which satisfies the condition 1, and the diagnosis unit 203 compares the driver model with the device information (own model information) and confirms that the driver model does not match the device information. Furthermore, since the job log 401 indicates that “OS=OS (1)”, which does not satisfy the condition 2, the diagnosis unit 203 does not add the countermeasure candidate to the displayed list.

Since there is no condition of “execute auto gray-level correction” for the item 1103, the diagnosis unit 203 displays the countermeasure candidate on the displayed list.

Since a condition of “(driver print) change color setting” for the item 1104 is “driver=“-”” and the job log 401 indicates that “driver=driver (1)”, which does not satisfy the condition, the diagnosis unit 203 does not add the countermeasure candidate to the displayed list.

Since a condition of “(driver print) adjust toner density” for the item 1105 is “driver≠“-”” and the job log 401 indicates that “driver=driver (1)”, which does not satisfy the condition, the diagnosis unit 203 does not add the countermeasure candidate to the displayed list.

Eventually, the displayed list is in a state where the countermeasure candidates for the items 1101 and 1103 are added thereto.

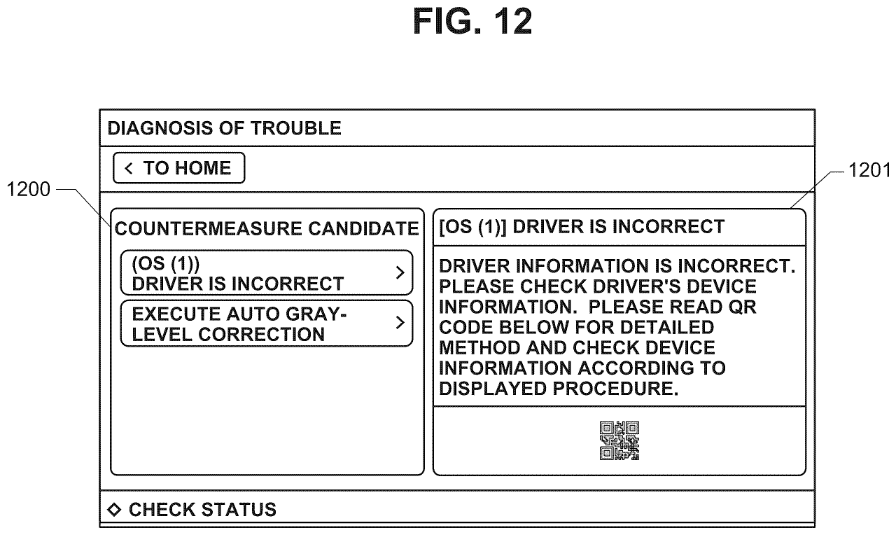

In step S1008, the diagnosis unit 203 checks whether there is a countermeasure candidate on the displayed list. In a case where there is a countermeasure candidate (YES in step S1008), the processing proceeds to step S1009. In step S1009, a diagnosis result is displayed as illustrated in FIG. 12 (second display unit). In the diagnosis result, a countermeasure candidate 1200 is displayed. Here, information corresponding to the items 1101 and 1103 are displayed as the countermeasure candidates. In step S1010, when detecting pressing of a menu button regarding “(OS (1)) driver is incorrect” as information corresponding to the item 1101, the diagnosis unit 203 displays detailed information 1201 regarding the selected countermeasure. Specifically, a displayed character string regarding “(OS (1)) acquire device information” for the item 1101 in FIG. 11 and an image of a QR Code® that is converted from a uniform resource locator (URL) for a manual are displayed. Such displayed contents are merely an example, and the displayed contents are not limited thereto.

While the description has been given of the example of extracting the countermeasure candidates in a case where the diagnosis content of “color is incorrect” and the item 701 are selected, the method of extracting the countermeasure candidates is similar in a case where a combination of another diagnosis content and another job is selected.

For example, in a case where a diagnosis content regarding stapling and the item 701 are selected, the diagnosis unit 203 makes a comparison with conditions of countermeasure candidates for items 1106 to 1108 regarding stapling on the countermeasure list 1100 and extracts a countermeasure candidate. The diagnosis unit 203 compares the conditions for the items 1106 to 1108 with information in the job log 401 corresponding to the item 701. Eventually, the countermeasure candidate for the item 1107 is added to the displayed list and displayed. In this manner, in a case where the diagnosis content regarding stapling is selected, countermeasure candidates regarding stapling and regarding the selected job are displayed.

Display of a countermeasure in the case where there is no job desired to be diagnosed, illustrated in step S508 in FIG. 5, is described in detail.

FIG. 7 illustrates an example of the screen on which candidate jobs for the diagnosis content are displayed, but there may be a case where no candidate job desired to be checked by the user exists. In this case, pressing the “no corresponding job” selection button 702 displays a countermeasure for the diagnosis content. The description here is given of a method of displaying a countermeasure in a case where the menu button regarding the diagnosis content 601 of “color is incorrect” in the “print” function is pressed and candidate jobs are displayed but there is no candidate job desired to be checked and the “no corresponding job” selection button 702 is pressed, for example, with reference to FIGS. 13 and 14.

FIG. 13 is a flowchart related to the second diagnosis processing executed by the diagnosis unit 203. The flowchart illustrates a flow of a diagnosis in which the CPU 110 causes the diagnosis unit 203 to perform in a case where the “no corresponding job” selection button 702 is pressed. After the diagnosis content 601 of “color is incorrect” is selected, the CPU 110 causes the diagnosis unit 203 to detect pressing of the “no corresponding job” selection button 702. Subsequently, in step S1301, the diagnosis unit 203 acquires the countermeasure list 1100 in FIG. 11. In step S1302, the diagnosis unit 203 sets the extraction conditions to all countermeasures to extract all countermeasure candidates. In step S1303, the diagnosis unit 203 acquires all the countermeasure candidates corresponding to the diagnosis content from the countermeasure list 1100. In step S1304, the diagnosis unit 203 adds the countermeasure candidates to the displayed list. In step S1305, the diagnosis unit 203 displays the countermeasure candidates in a countermeasure display section 1400, which is illustrated in FIG. 14, in the operation unit 115.

Information corresponding to the items 1101 to 1104 are displayed as a display example of the countermeasure candidates in step S1305. In a case where display of the countermeasure candidates extends beyond the screen, only some of the countermeasure candidates are displayed, and the other countermeasure candidates can be checked by scrolling. While checking by scrolling is described as an example in the case where the display extends beyond the screen, this is not restrictive, and checking can be performed by displaying while switching between pages. While the first diagnosis processing extracts a countermeasure based on the job log corresponding to the selected item, the second diagnosis processing does not perform an extraction operation using the job log because there is no job log.

In step S1306, when detecting pressing of a menu button regarding “(OS (1)) driver is incorrect” as the information corresponding to the item 1101, the diagnosis unit 203 displays detailed information regarding the selected countermeasure in a countermeasure detail display section 1401. Specifically, a displayed character string regarding “(OS (1)) acquire device information” for the item 1101 in FIG. 11 and an image of a QR Code® that is converted from a URL for a manual are displayed.

Such display contents are merely an example, and the displayed contents are not limited thereto.

As described above, in the present exemplary embodiment, countermeasure candidates for a diagnosis content are narrowed down according to job log information regarding a job selected by a user to display only candidates that are potentially relevant to the diagnosis content and not to display candidates that are not relevant to the diagnosis content. Furthermore, in a case where there is no corresponding job, all countermeasure candidates for the diagnosis content are displayed.

The second diagnosis processing does not narrow down countermeasure candidates based on the job log in a diagnosis result. Thus, in a case where the same diagnosis content is selected by the first diagnosis processing and the second diagnosis processing, the number of countermeasure candidates to be displayed when the first diagnosis processing performs a diagnosis is smaller than that when the second diagnosis processing performs diagnosis. As a result, in a case where the first diagnosis processing performs a diagnosis, the user can more easily recognize the cause of a failure. In addition, the case where the second diagnosis processing performs a diagnosis is a case where the user is unable to grasp in which job the failure has occurred. Thus, the second diagnosis processing performs a diagnosis without using the job log and can thereby present countermeasures to the user. After the diagnosis performed by the second diagnosis processing, although the number of displayed countermeasures is larger, the user can find the cause of the failure by selecting the diagnosis content.

A second exemplary embodiment will be described below with reference to the accompanying drawings. In the second exemplary embodiment, in a case where there is no candidate job to be selected by a user at the time of performing a diagnosis, the diagnosis unit 203 makes an inquiry to the user about whether to display all countermeasures for a diagnosis content and then displays the countermeasures.

Differences from the first exemplary embodiment will be described below.

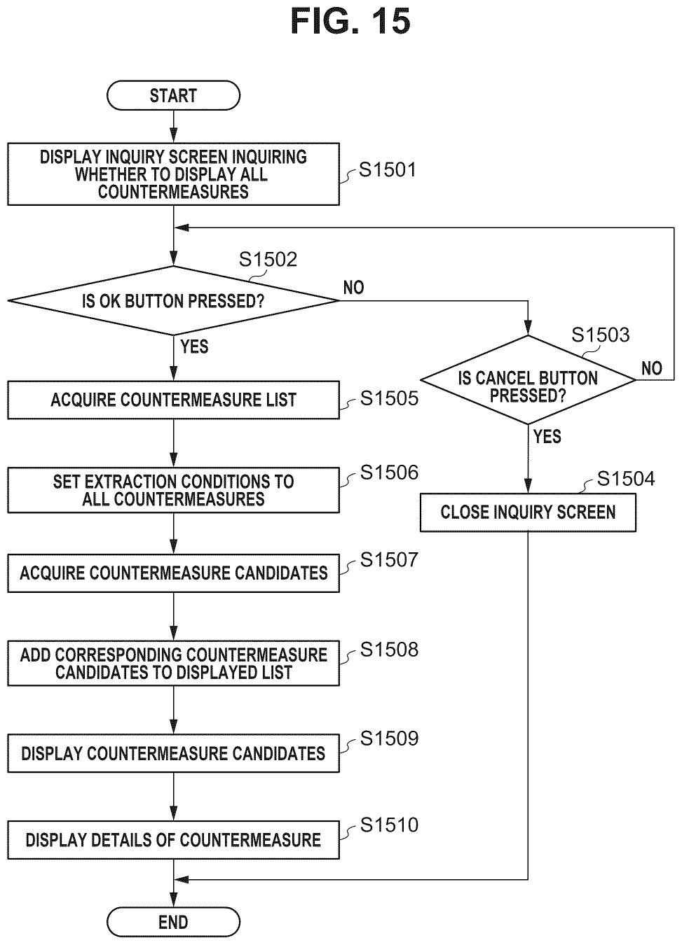

In the diagnosis that the diagnosis unit 203 is caused to perform by the CPU 110, there may be a case where there is no candidate job desired to be checked by the user in FIG. 7. To address such a case, a description will be given of processing of making an inquiry to the user about whether to display all countermeasures after the “no corresponding job” selection button 702 is pressed, with reference to the flowchart in FIG. 15.

The description here is given of display of a countermeasure, for example, in a case where the menu button regarding the diagnosis content 601 of “color is incorrect” in the “print” function is pressed and candidate jobs are displayed, but there is no candidate job desired to be checked, and the “no corresponding job” selection button 702 is pressed.

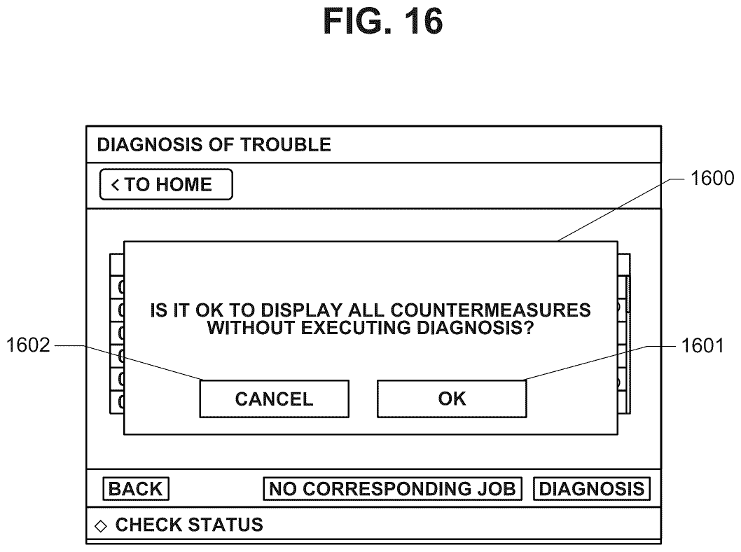

After the diagnosis content 601 of “color is incorrect” is selected, the CPU 110 causes the diagnosis unit 203 to detect that the user has pressed the “no corresponding job” selection button 702 since there is no candidate job desired to be checked. Then, in step S1501, the diagnosis unit 203 makes an inquiry to the user about whether to display all countermeasures. FIG. 16 illustrates an example of an inquiry screen for making an inquiry to the user about whether to display all the countermeasures when the “no corresponding job” selection button 702 is pressed. As illustrated in FIG. 16, the inquiry screen is displayed to make an inquiry about whether to display all the countermeasures on a screen 1600. In step S1502, the diagnosis unit 203 determines whether an OK button 1601 is pressed on the screen 1600. In a case where the OK button 1601 is pressed (YES in step S1502), the processing proceeds to step S1505 to execute processing of displaying all the countermeasures.

In a case where the OK button 1601 is not pressed (NO in step S1502), the processing proceeds to step S1503. In step S1503, the diagnosis unit 203 determines whether a cancel button 1602 is pressed. In a case where the cancel button 1602 is pressed (YES in step S1503), the processing proceeds to step S1504. In step S1504, the screen 1600 is closed.

In a case where neither the OK button 1601 nor the cancel button 1602 is pressed (NO in step S1503), the processing returns to step S1502 while the screen 1600 remains displayed.

Subsequently, in step S1505, the diagnosis unit 203 acquires the countermeasure list 1100 illustrated in FIG. 11. A description here is given of processing of displaying a countermeasure based on the diagnosis content of “color is incorrect” as an example.

In step S1506, the diagnosis unit 203 sets extraction conditions to all countermeasures to extract all countermeasure candidates.

In step S1507, the diagnosis unit 203 acquires all the countermeasure candidates corresponding to the diagnosis content from the countermeasure list 1100.

For example, in a case where the diagnosis content of “color is incorrect” is selected, since the extraction conditions are set to all the countermeasures, all the countermeasures for the items 1101 to 1105 on the countermeasure list 1100 correspond to the countermeasure candidates. Then, in step S1508, the corresponding countermeasure candidates are added to the displayed list.

In step S1509, the countermeasure candidates are displayed in the countermeasure display section 1400, which is illustrated in FIG. 14, in the operation unit 115 (the second display unit).

The information corresponding to the items 1101 to 1104 are displayed as a display example of the countermeasures in step S1509. In a case where display of the countermeasure candidates extends beyond the screen, only some of the countermeasure candidates are displayed, and the other countermeasure candidates can be checked by scrolling. While checking by scrolling is described as an example in the case where the display extends beyond the screen, this is not restrictive, and checking can be performed by displaying while switching between pages.

In step S1510, when detecting pressing of the menu button regarding “(OS (1)) driver is incorrect” for the item 1101, the diagnosis unit 203 displays detailed information regarding the selected countermeasure in the countermeasure detail display section 1401. Specifically, a displayed character string regarding “(OS (1)) acquire device information” for the item 1101 in FIG. 11 and an image of a QR Code® that is converted from a URL for a manual are displayed.

Such displayed contents are merely an example, and the displayed contents are not limited thereto.

As described above, in the present exemplary embodiment, in a case where there is no candidate job to be selected by the user, the diagnosis unit 203 makes an inquiry to the user about whether to display all countermeasures for the diagnosis content and then displays the countermeasures.

There has been a case where there is no job desired to be diagnosed on the job list and a countermeasure cannot be browsed. To address such a case, in the present exemplary embodiment, displaying the inquiry screen allows the user to select between checking of all the countermeasures or interruption of a diagnosis since there is no job desired to be selected.

In a third exemplary embodiment, in a case where there is no job log in a job log DB for creating job candidates to be selected by a user at the time of diagnosis and thus a job candidate cannot be displayed, all countermeasures in accordance with a diagnosis content are displayed.

A configuration of the image forming apparatus 100 is similar to the configuration thereof in the first exemplary embodiment illustrated in FIG. 1. Differences from the first exemplary embodiment will be described below.

In the third exemplary embodiment, a description will be given of processing of displaying all countermeasures in accordance with the diagnosis content in a case where there is no job log in the job log DB for creating job candidates and a job candidate cannot be displayed. The diagnosis unit 203 is caused to execute the processing by the CPU 110. The image forming apparatus 100 can delete one or more records included in the job history. A job log stored in the storage unit 113 is deleted from a viewpoint of information security. In this manner, since there is a conceivable case where a diagnosis is performed in a state where there is no job log, such a case is described.

Processing described herein is processing limited to a case where there is no job log (NO in step S803) in the flowchart in FIG. 8 with respect to display of the job list described in the first exemplary embodiment. In this case, it is determined as NO in step S803, and the flowchart ends. Then, processing similar to the processing in the flowchart in FIG. 13 is executed. After the diagnosis content illustrated in FIG. 6 is selected, a diagnosis is started without selection of an item illustrated in FIG. 7 and without pressing of a diagnosis execution button. Since there is no job log, the user need not select a job log nor go through an effort of pressing the “no corresponding job” selection button and the diagnosis execution button, which increases usability.

Further, similar to the contents described in the second exemplary embodiment, the countermeasure for the diagnosis content may be displayed after notification is provided to the user that it is impossible to display the job history list in a case where no candidate job can be displayed.

According to the present disclosure, it is possible to perform a diagnosis even in a case where no job can be selected, and it is possible for the user to grasp a countermeasure for a failure.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-060664, which was filed on Apr. 4, 2024 and which is hereby incorporated by reference herein in its entirety.

What is claimed is:

1. An information processing apparatus having a function of executing a job, the information processing apparatus comprising:
a display;
at least one processor; and
at least one memory that is in communication with the at least one processor, wherein the at least one memory stores instructions for causing the at least one processor and the at least one memory to:
control the display to display a plurality of items respectively corresponding to a plurality of jobs executed by the information processing apparatus;
accept a selection of an item from the plurality of items;
perform a diagnosis of the information processing apparatus regarding the item based on acceptance of the selection of the item; and
in a case where the plurality of items is displayed, perform a diagnosis of the information processing apparatus without the selection of the item from the plurality of items.

2. The information processing apparatus according to claim 1, wherein the function of executing the job includes at least one of a function of a printer configured to perform printing and a function of a scanner configured to read an image as data.

3. The information processing apparatus according to claim 1, wherein the at least one memory further stores instructions for causing the at least one processor and the at least one memory to:
accept selection of a diagnosis content; and
perform the diagnosis of the information processing apparatus regarding the diagnosis content and the item based on acceptance of both the selection of the diagnosis content and the selection of the item.

4. The information processing apparatus according to claim 1, wherein the at least one memory further stores instructions for causing the at least one processor and the at least one memory to:
accept selection of a diagnosis content; and
in a case where the display displays the plurality of items after acceptance of the selection of the diagnosis content, perform a diagnosis of the information processing apparatus without the selection of the item from the plurality of items.

5. The information processing apparatus according to claim 4, wherein the at least one memory further stores instructions for causing the at least one processor and the at least one memory to, in a case where the accepted selection of the diagnosis content is a selection of a predetermined diagnosis content, perform control of not executing the diagnosis of the information processing apparatus.

6. The information processing apparatus according to claim 5,
wherein the at least one memory further stores instructions for causing the at least one processor and the at least one memory to transmit image data read by a scanner of the information processing apparatus to an external apparatus, and
wherein the predetermined diagnosis content is a diagnosis menu regarding the transmission of the image data read by the scanner.

7. The information processing apparatus according to claim 1, further comprising:
storage configured to store information regarding the job executed by the information processing apparatus,
wherein the at least one memory further stores instructions for causing the at least one processor and the at least one memory to:
delete the information from the storage unit; and
in a case where the information is not stored in the storage unit, perform a diagnosis of the information processing apparatus after acceptance of a selection of a diagnosis content without the selection of the item.

8. A method for an information processing apparatus having a function of executing a job, the method comprising:
displaying a plurality of items respectively corresponding to a plurality of jobs executed by the information processing apparatus;
accepting a selection of an item from the plurality of items;
performing a first diagnosis of the information processing apparatus regarding the item based on acceptance of the selection of the item; and
performing a second diagnosis of, in a case where the plurality of items is displayed, the information processing apparatus without the selection of the item from the plurality of items.
